(19) United States
(12) Patent Application Publication
(10) Pub. No.: US 2004/0231179 A1
(43) Pub. Date: Nov. 25, 2004

(54) Dry air supply device

(75) Inventors: Noriaki Kodama, Tokyo (JP); Masaji Kurosawa, Tokyo (JP); Katsuhiro Yamashita, Tokyo (JP)

Correspondence Address: NIXON & VANDERHYE, PC, 1100 N GLEBE ROAD, 8TH FLOOR, ARLINGTON, VA, 22201-4714, US

(73) Assignee: Nichias Corporation, Tokyo (JP)

(21) Appl. No.: 10/829,464

(22) Filed: Apr. 22, 2004

(30) Foreign Application Priority Data
Apr. 25, 2003 (JP) P. 2003-121220

(51) Int. Cl. F26B 21/06

(52) U.S. Cl. 34/79

(57) ABSTRACT

The present invention provides a dry air supply device for supplying, into a target space, dry air from which moisture and organic materials have been removed, the device comprising: a plurality of rotors disposed in series, each of which is configured to carry an adsorbent thereon and is rotatably supported; partition members which are arranged at outermost end portions of the rotors and between the rotors so as to partition a rotary zone of each rotor into an adsorption zone, a regeneration zone and a cooling zone; a driving member which rotatably drives the rotors; a supply passage which allows sucked air to pass through the adsorption zone to obtain dry air from which moisture and organic materials have been removed, and which supplies the dry air into the target space; and an exhaust passage which allows a portion of the dry air to pass through the cooling zone, then heats the cooled air, and then allows the heated air to pass through the regeneration zone to separate the moisture and the organic materials from the adsorbent thereby.

### FIELD OF THE INVENTION

The present invention relates to a dry air supply device.

### BACKGROUND OF THE INVENTION

The manufacture of a semiconductor device includes steps for applying various treatments such as oxidation, diffusion, CVD and the like to a substance to be processed such as a semiconductor wafer, and various treatment devices (for example, a heat treatment device and the like) for performing these steps are used. For example, in a vertical-type heat treatment device, between a transport vessel which houses a plurality of (e.g., 25 sheets of) wafers and a treatment vessel which houses the wafers and applies given treatments to the wafers, a transport space (also referred to as a loading area) which performs the transportation of the wafers is provided.

Conventionally, to suppress the growth of a natural oxide film of the wafer in the above-mentioned transport space, a large quantity (250 to 400 litter/min) of an inert gas (e.g., a nitrogen gas) is supplied to the transport space so that the atmosphere in the transport space have an oxygen concentration of 30 ppm or lower. Further, to remove an organic gas in the above-mentioned transport space, a chemical filler is provided. However, the above-mentioned method consumes a large quantity of expensive nitrogen gas and hence, a running cost is extremely increased and, at the same time, there exists a possibility that a lack of oxygen may occur due to the increase of the nitrogen gas. Further, although it is possible to remove organic materials using a chemical filter, it is difficult to regenerate the chemical filter by removing the organic materials adhered to the chemical filter.

As the related art, the invention which supplies a dry gas having a low dew point into a transport space (see, for example, Patent Document 1) and the invention on a dry dehumidifying device which can obtain a dry gas having a low dew point (see, for example, Patent Documents 2 and 3) have been proposed.

Patent Document 1: JP 06-267933 A

Patent Document 2: JP 2000-296309 A

Patent Document 3: JP 63-050047 A

However, in the above-mentioned dry dehumidifying device and the dry air supply device which can provide a dry gas having a low dew point, between two (two stages) rotors which are configured to carry an adsorbent thereon, pipes and cooling means are arranged thus making the structure complicated and the device large-sized. Further, since a sealing member of a partition member contacts with an end surface of the rotor in a sliding manner, there exists a possibility that particles may be generated.

### SUMMARY OF THE INVENTION

The present invention has been made in view of the above-mentioned circumstances.

Accordingly, an object of the present invention is to provide a dry air supply device which can simplify the structure and can miniaturize the device.

Another object of the present invention is to provide a dry air supply device which can suppress the generation of particles attributed to a slide contact of a sealing member of a partition member with an end surface of a rotor.

Other objects and effects of the invention will become apparent from the following description

The above-described objects of the invention have been achieved by providing the following apparatuses (1) to (5).

(1) A dry air supply device for supplying, into a target space, dry air from which moisture and organic materials have been removed, the device comprising;

a plurality of rotors disposed in series, each of which is configured to carry an adsorbent thereon and is rotatably supported;

partition members which are arranged at outermost end portions of the rotors and between the rotors so as to partition a rotary zone of each rotor into an adsorption zone, a regeneration zone and a cooling zone;

a driving member which rotatably drives the rotors;

a supply passage which allows sucked air to pass through the adsorption zone to obtain dry air from which moisture and organic materials have been removed, and which supplies the dry air into the target space; and

an exhaust passage which allows a portion of the dry air to pass through the cooling zone, then heats the cooled air, and then allows the heated air to pass through the regeneration zone to separate the moisture and the organic materials from the adsorbent thereby.

According to the constitution of the dry air supply device in item (1), pipes which connect the front and rear rotors and a cooler can be eliminated whereby the structure can be simplified and the device can be made compact.

(2) The dry air supply device according to item (1) above, wherein the partition members include;

a circumferential member having a circumferential sealing portion; and

radial members having radial sealing portions.

According to the constitution of the dry air supply device in item (2), the end surface of the rotor can be surely defined into the respective zones and, at the same time, mixing or leaking of the air into the neighboring zones can be prevented.

(3) The dry air supply device according to item (2) above, wherein the circumferential sealing member includes:

rotary-side fins which are concentrically formed on an outer peripheral portion of an end portion of the rotor; and

fixed-side fins which are concentrically formed on the partition members such that the fixed-side fins are alternately overlapped to the rotary-side fins in a non-contact manner.

According to the constitution of the dry air supply device of item (3), it is possible to suppress or prevent the generation of particles due to the so-called non-contact type labyrinth structure.

(4) The dry air supply device according to item (2) above, wherein the radial sealing portion includes a plurality of fins which are formed in parallel with the radial members, and has a structure which allows air to pass through at approximately a center portion among the fins.

According to the constitution of dry air supply device in item (4), it is possible to complement the sealing performance of the only one-side fin structure and hence, the wraparound of the air from the respective zones can be prevented.

(5) The dry air supply device according to item (1) above, wherein the rotors are set to have rotational speeds which exhibit optimum characteristics, respectively.

According to the constitution of the dry air supply device of item (5), it is possible to efficiently obtain the clean dry air having a low dew point.

### BRIEF DESCRIPTION OF THE DRAWINGS

FIG. 1 is a schematic longitudinal cross-sectional view of the dry air supply device according to a first embodiment of the present invention.

FIG. 2 is a schematic perspective view for explaining the sealing portion.

FIG. 3 is an enlarged cross-sectional view taken along the line A-A in FIG. 2.

FIG. 4 is an enlarged cross-sectional view taken along the line B-B in FIG. 2.

FIG. 5 is a perspective view showing one example of the rotor.

FIG. 6 is a perspective view showing one example of the support frame which rotatably supports the rotor.

FIG. 7 is a schematic exploded perspective view of the dry air supply device according to a second embodiment of the present invention.

The reference numerals used in the drawings denote the followings, respectively.

1: dry air supply device

2a, 2b: rotor

3 (3a, 3b): partition member

4A, 4B: motor (driving member)

S: adsorption zone

U: regeneration zone

T: cooling zone

5: supply passage

6: discharge passage

17: rotary-side fin

18: fixed-side fin

19: fin

20: communication flow hole

### DETAILED DESCRIPTION OF PREFERRED EMBODIMENTS

The mode for carrying out the present invention is explained in detail below in conjunction with attached drawings hereinafter.

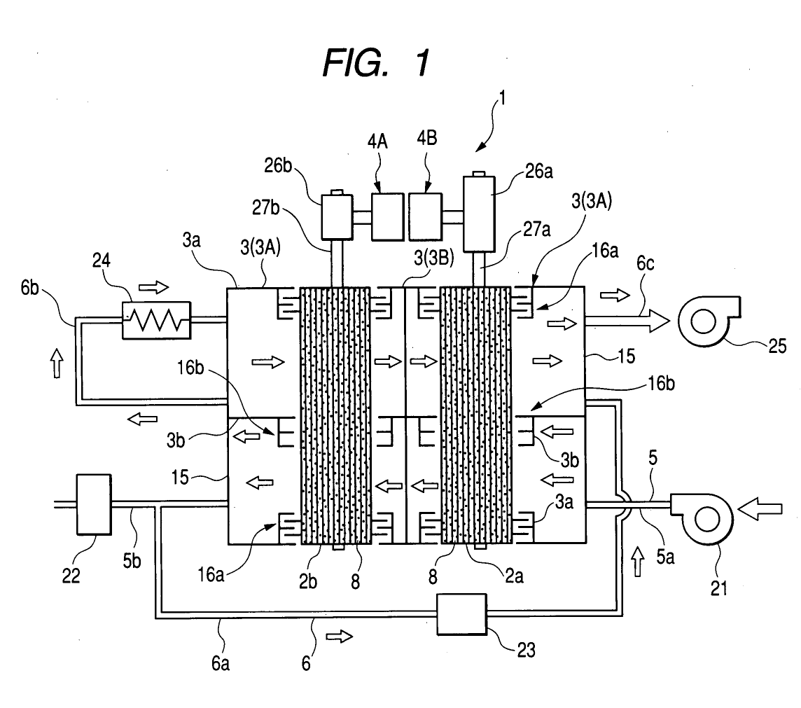

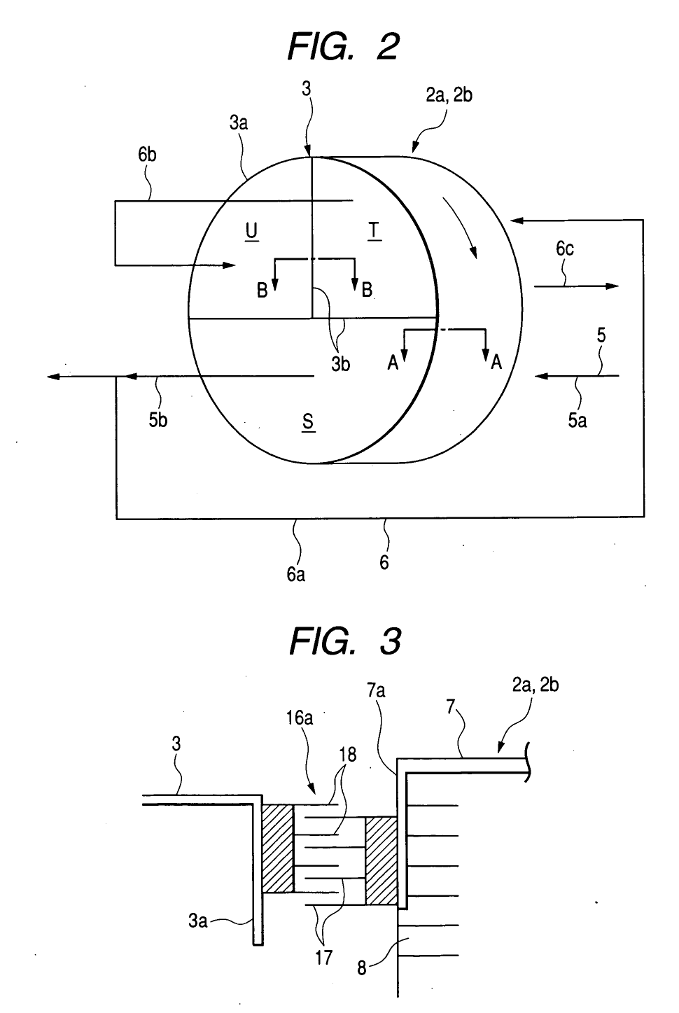

In FIG. 1, reference numeral 1 indicates a dry air supply device for supplying dry air having a low dew point into a target space such as a transport space of a semiconductor manufacturing device or the like. The dry air supply device 1 is a device which supplies, into the target space, the dry air from which moisture and organic materials have been removed, and includes a plurality of rotors (in this embodiment, two rotors) 2a, 2b disposed in series, each of which is configured to carry an adsorbent thereon and is rotatably supported; partition members 3 (3A, 3B) which are arranged at outermost end portions of the rotors 2a, 2b and between the rotors 2a, 2b so as to partition a rotary zone of each rotor into an adsorption zone S, a regeneration zone U and a cooling zone T; motors 4A, 4B which serve as the driving members for rotatably driving the rotors 2a, 2b; a supply passage 5 which allows sucked air to pass through the adsorption zone to obtain dry air from which moisture and organic materials have been removed, and which supplies the dry air into the target space; and an exhaust passage 6 which allows a portion of the dry air to pass through the cooling zone T, then heats the cooled air, and then allows the heated air to pass through the regeneration zone U to separate the moisture and organic materials adsorbed by the adsorbent from the adsorbent.

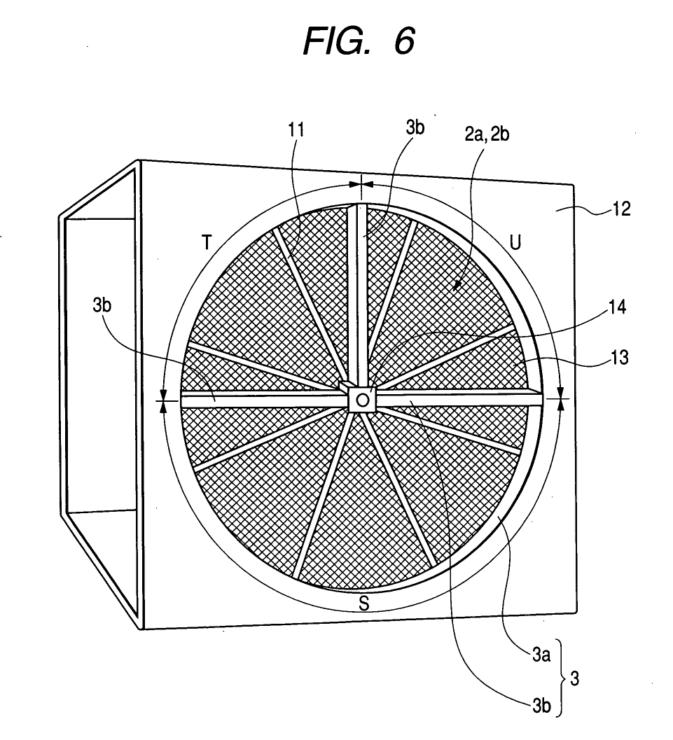

Each one of the above-mentioned rotors 2a, 2b mainly comprises: a metal-made cylindrical body 7 which is opened at both ends thereof; and a honeycomb structural body 8 which is mounted in the inside of the cylindrical body 7 and which comprises a base material in which an adsorbent is impregnated. The rotors 2a, 2b may be rotatably supported by rollers or the like at their outer peripheral portions. Alternatively, the rotors 2a, 2b may be rotatably supported by a rotary shaft 10 which is provided at the axis portion of the rotors 2a, 2b as shown in FIG. 5. When the rotary shaft 10 is used, provided in the inside of the cylindrical body 7 are spokes 11 which radially extend from the rotary shaft 10 and partition the inside of the cylindrical body 7 into a plurality of chamber (e.g., eight chambers) having a sector-shaped cross section. The honeycomb structural bodies 8 which are shaped in a sector-shaped cross section are placed in the respective chambers. In the course of flowing air in the axial direction of the rotors 2a, 2b, the adsorbent in the honeycomb structural bodies 8 adsorb moisture and organic materials contained in air and remove them from the air and, thereby, a dry air can be obtained.

As the adsorbent of the rotor 2a which is the front stage rotor, to realize the efficient adsorption of moisture and the efficient adsorption of the organic materials as the pre-dehumidifying (outlet dew temperature: −20° C.), it is preferable to use, for example, faujasite Y type zeolite (A₅₆Si₁₃₆O₃₈₄₄) As the adsorbent of the rotor 2b which is the rear stage rotor, to adsorb the moisture as the low dew point dehumidifying (outlet dew point temperature: −80° C.), it is preferable to use, for example, faujasite X type zeolite (A₉₆Si₉₆O₃₈₄).

On the other hand, as the base material of the honeycomb structural body 8, it is preferable to use inorganic fiber paper for its excellent heat resistance, wear resistance, etc. The honeycomb structural body 8 is produced by forming the inorganic fiber paper in a honeycomb shape. Examples of the method for carrying the adsorbent on the base material include, for example, a method of impregnating a slurry containing an adsorbent into the base material by spraying or by brush coating, followed by drying.

In the case of having the rotary shaft 10, the rotors 2a, 2b are rotatably supported, for example, in a box-like or a frame-like support frame 12 as shown in FIG. 6. In the case of the illustrated example, opening portions 13 which correspond to both end portions of the rotors 2a, 2b are formed in both end portions of the support frame 12. A partition member 3 is attached to each opening portion 13, and the rotary shaft 10 of the rotor is rotatably supported at the center portion of the partition member 3 by way of a bearing 14. More specifically, the partition members 3 are roughly classified into outermost end partition members 3A which are arranged at the outermost end portions of both rotors 2a, 2b (i.e., both left and right ends in FIG. 1) and an intermediate partition member 3B which is arranged between rotors 2a, 2b. These partition members have substantially the same structure. However, while the outermost end partition member 3A has a sealing portion on one-side surface thereof, the intermediate partition member 3B has sealing portions on both-side surfaces thereof. The outermost end partition members 3A and the intermediate partition member 3B are fixed to the support frame 12. The outermost end partition members 3A are provided with cover members 15 which cover outer sides of the outermost end partition members 3A, and pipes which are communicated with respective zones S, U, T are connected to the cover members 15.

The partition member 3 comprises: an annular circumferential member 3a which corresponds to a peripheral portion of an end portion of the rotor or cylindrical body 7; and radial members 3b which are extended from the center (e.g., the bearing) to the circumferential member 3a. The radial members 3b includes a radial sealing portion 16b which seals among neighboring zones S, U, T at a portion close to an end surface of the honeycomb structural body 8 (i.e., an end surface of the rotor) The circumferential member 3a includes a circumferential sealing portion 16a which is arranged close to a flange 7a provided at an end periphery of the rotor or cylindrical body 7 and which seals between the inside and the outside of the circumferential sealing portion 16a In this embodiment, the sealing portion takes the labyrinth structure which is not contact with the rotor.

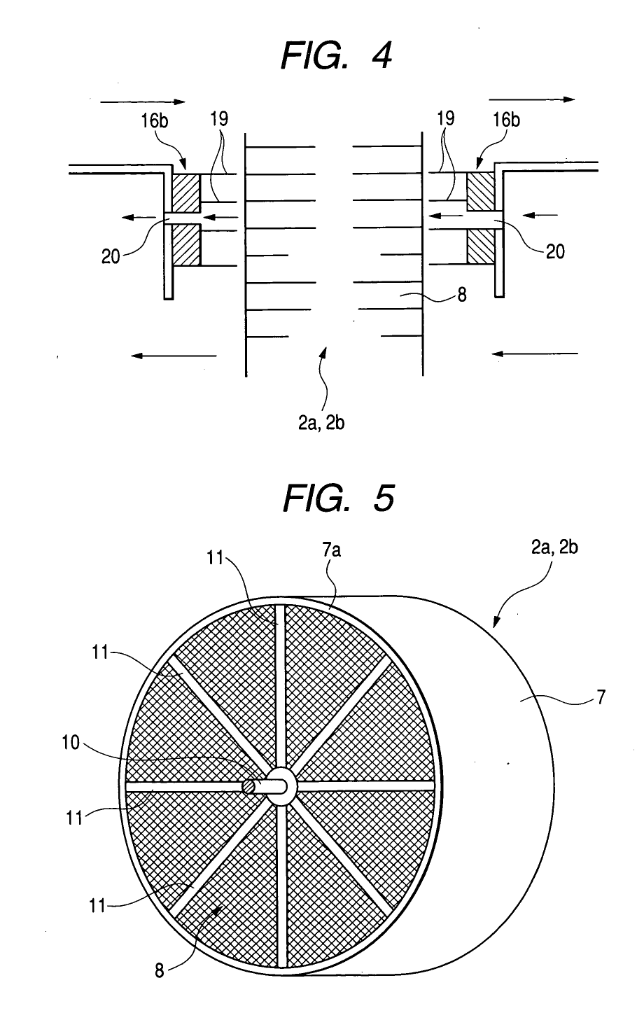

As shown in FIG. 3, the above-mentioned circumferential sealing portion 16a comprises: a plurality of rotary-side fins (e.g., four rotary-side fins) 17 which are concentrically disposed on the flange 7a serving as an end peripheral portion of the rotors 2a, 2b; and a plurality of fixed-side fins (e.g., four fixed-side fins) 18 which are concentrically disposed on the circumferential partition member 3a such that the fixed-side fins 18 are alternately overlapped to the rotary-side fins 17 in a non-contact manner. These fins 17, 18 are formed of metal or heat resistant resin such as PTFE.

As shown in FIG. 4, the radial sealing portion 16b comprises; a plurality of fins (e.g., four fins) 19 which are disposed in parallel to the radial member 3b; and the structure which allows the air to flow at an approximately center portion among the fins 19, that is, communication flow holes (e.g., slit holes) 20 which are formed at an approximately center portion among the fins 19. The radial sealing portion 16b adopts the one-side fin structure formed only at the radial partition member 3b side such that the radial sealing portion 16b ensures the non-contact state with respect to the rotor side The sealing performance may be not enough with only the one-side fin structure Accordingly, air is made to flow through the communication flow holes 20 formed at the approximately center portion among the fins 19 (also referred to as a “widthwise approximately center portion of the radial sealing portion 16b” or a “approximately center portion of a group of fins 19). Hence, the air flows toward the rotor or flows from the rotor to the communication flow hole 20, and wraparound of the air among the respective zones can be prevented by the air flow, thus ensuring the sealing performance.

As the above-mentioned supply passage 5, an air intake pipe Sa having a fan 21 which sucks air in the transport space of the heat treatment device or in a usual atmospheric space and which feeds the air into the adsorption zone S is connected to the cover member 15 of the front stage rotor 2a, while a dry air supply pipe 5b which supplies, into a target space (e.g., the transport space of the heat treatment device), the dry air having a low dew point having removed organic materials and moisture therefrom through the adsorption zones S of the respective rotors is connected to the cover member 15 of the rear stage rotor 2b. It is preferable that the dry air supply pipe 5b illustrated in the drawing is provided with a filter 22 for removing particles However, in the case of considerably less generation of particles because of the non-contact sealing structure, the provision of the filter 22 may be omitted.

On the other hand, as the exhaust passage 6, a first pipe 6a, which is branched from the dry air supply pipe 5b, is communicably connected with the cooling zone T of the cover member 15 of the front stage rotor 2a. It is preferable that the first pipe 6a is provided with a cooler 23 which serves as a cooling member for cooling the dry air to a given temperature (e.g., about 15° C.). A second pipe 6b which connects the cooling zone T and the regeneration zone U is connected with the cover member 15 of the rear stage rotor 2b. In order for regenerating the adsorbent in the regeneration zone U, the second pipe 6b is provided with a heating member such as a heater 24 which heats air to a given temperature for regeneration.

During the normal operation, the air for regeneration is heated to a temperature of about 130 to 200° C. by the heater 24 and is supplied to the regeneration zone U so as to separate and remove the moisture and gaseous impurities (organic materials) that are adsorbed in the adsorbent. To separate and remove an organic compound having a high boiling point from the adsorbent, it is preferable to heat the air for regeneration to a high temperature of about 250 to 400° C. by the heater 24 and to periodically supply the heated air to the regeneration zone U. To the cover member 15 of the front stage rotor 2a, a third pipe 6c which has a fan 25 for exhausting the air for regeneration from the regeneration zone U is connected.

To rotate the above-mentioned rotors 2a, 2b, two motors 4A, 4B are used in this embodiment. Belt wheels (also referred to as “pulleys”) 26a, 26b are respectively mounted on rotary shafts of the motors 4A, 4B and endless belts 27a, 27b are wound around between the respective belt wheels 26a, 26b and the respective rotors 2a, 2b Further, by making diameters of two belt wheels 26a, 26b different from each other or by controlling the rotations of the motors 4A, 4B, the rotors 2a, 2b are set or controlled to have rotational speeds at which these rotors 2a, 2b exhibit optimum properties thereof, respectively. Herein, one common motor may be used as the driving member of the respective rotors 2a, 2b.

In this embodiment, the rotational speed of the front stage rotor 2a is set faster than the rotational speed of the rear stage rotor 2b by making the diameter of the belt wheel 26a for the front-stage rotor 2a larger than the diameter of the belt wheel 26b for the rear-stage rotor 2b. Air which has a high moisture content and which contains organic materials is introduced into the front stage rotor 2a. Therefore, in order to make the rotor 2a adsorb larger amounts of moisture and organic materials and to efficiently regenerate the adsorbent by removing and separating the adsorbed moisture and organic materials, the rotational speed of the front stage rotor 2a in this embodiment is set, for example, to 10 rph, although the rotational speed depends on the area ratio among the adsorption zone S, the regeneration zone U and the cooling zone T (which ratio is 2:1:1 in the illustrated example). The air from which the moisture and the organic materials have been removed is introduced into the rear stage rotor 2b. Therefore, to obtain the dry air having a lower dew point, the rotational speed of the rear stage rotor 2b is set to 0.5 rph. Further, for the same reasons, it is desirable that the length (e.g., 200 mm) of the front stage rotor 2a is set smaller than the length (e.g., 400 mm) of the rear stage rotor 2b.

According to the dry air supply device 1 having the above-mentioned constitution, the device 1 includes: the plural rotors 2a, 2b disposed in series, each of which is configured to carry an adsorbent thereon and is rotatably supported; the partition members 3 which are arranged at the outermost end portions of the rotors 2a, 2b and between the rotors 2a, 2b so as to partition the rotary zone of each rotor 2a, 2b into the adsorption zone S, the regeneration zone U and the cooling zone T; the supply passage 5 which allows sucked air to pass through the adsorption zone S to obtain dry air from which moisture and organic materials have been removed, and which supplies the dry air into the target space, and the exhaust passage 6 which allows a portion of the dry air to pass through the cooling zone T, then heats the portion of the air and makes the portion of the air pass through the regeneration zone U to separate the moisture and the organic materials from the adsorbent. Further, the dry air supply device 1 adopts the integral structure which couples or connects the front and rear rotors 2a, 2b by way of the partition members 3. Due to such a constitution, it is possible to eliminate pipes for connecting the front and rear rotors 2a, 2b and a cooler, which were used conventionally, and hence the structure can be simplified and the device can be made compact. Since the partition member 3 comprises the circumferential member 3a having the circumferential sealing portion 16a and the radial members 3b having the radial sealing portion 16b, it is possible to surely define the respective zones S, U and T at end surfaces of the rotors 2a, 2b and, at the same time, mixing or leaking of air into neighboring zones can be prevented.

The dry air supply device 1 adopts the structure which can prevent the inflow of the air from the neighboring zones, by employing the above-mentioned structure of the partition members 3 and also by making use of the pressure difference of the air which passes through the respective zones. In this embodiment, the pressure of the air which passes through the adsorption zone S is made high, and the airs which pass through the cooling zone T and regeneration U are set to have a sequentially reduced pressure in this order. To be more specific, the dry air supply device 1 is configured such that the fan which supplies the air into the adsorption zone S is arranged at an upstream side of the adsorption zone S, and the fan which supplies the air into the regeneration zone U is arranged at a downstream side of the regeneration zone U, thus making the pressure of the air which passes through the adsorption zone S, the cooling zone T and the regeneration zone U sequentially reduced in this order.

The circumferential sealing portion 16a comprises the rotary-side fins 17 which are concentrically formed on the outer peripheral portion of the end portion of the rotors 2a, 2b and the fixed-side fins 18 which are concentrically formed on the partition member 3 such that the fixed-side fins 18 are alternately overlapped to the rotary-side fins 17 in a non-contact manner. Accordingly, the generation of particles can be suppressed or prevented by this arrangement which is so-called non-contact type labyrinth structure. The radial sealing portion 16b includes a plurality of fins 19 formed in parallel to the radial members 3b and adopts the structure (e.g., the communication flow hole 20) which allows the air to flow into the approximately center portion among the fins 19. Due to such a constitution, the sealing function obtained only by the one-side fin structure can be complemented and hence, it is possible to prevent the wraparound of the air from the respective zones S, T and U. Since the rotors 2a, 2b are set to the rotational speeds which allow the rotors 2a, 2b to exhibit the optimum properties, respectively, it is possible to efficiently obtain the clean dry air having a low dew points.

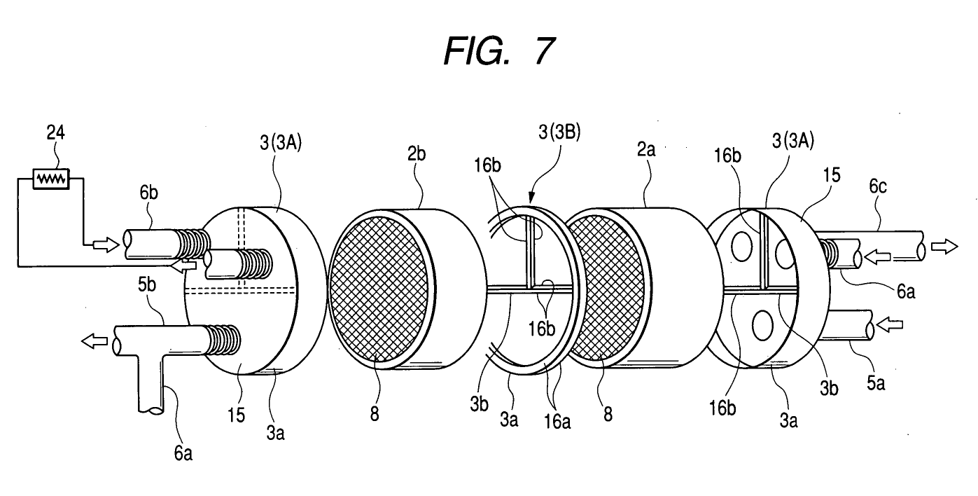

FIG. 7 is a schematic exploded perspective view of the dry air supply device according to a second embodiment of the present invention In FIG. 7 showing the second embodiment, the same reference symbols are given to parts identical with or equivalent to the above-mentioned first embodiment, and explanation for those parts is omitted herein. Between the front stage rotor 2a and the rear stage rotor 2b, a partition member 3 (an intermediate partition member 3B) having sealing portions at both surfaces thereof is arranged, and cover members 15 having partition members 3 (outer end partition members 3A) are arranged at the outermost end portions of the rotors 2a, 2b.

Referring to other embodiments, contact-type sealing members may be used as the sealing portions. As the contact-type sealing member, a sealing member having a base material made of foamed fluoro-rubber and having its slide contact surface thereof covered with a sheet made of a heat-resistant and wear-resistant resin having a low friction coefficient (e.g., PTFE) can be used. Also with respect to the dry air supply device of this embodiment, in the same manner as the above-mentioned embodiment, the device adopts the integrated structure in which two front and rear rotors 2a, 2b are connected by way of the partition member 3 and hence, pipes which connect the front and rear rotors 2a, 2b and a cooler can be eliminated, whereby the structure can be simplified and the device can be made compact. According to this embodiment, since the contact-type sealing member is adopted, the generation of particles is expected. Accordingly, it is desirable to provide a filter to a dry air supply pipe.

While the present invention has been described in detail and with reference to specific embodiments thereof, it will be apparent to one skilled in the art that various changes and modifications can be made therein without departing from the spirit and scope thereof.

This application is based on Japanese patent application No. 2003-121220 filed Apr. 25, 2003, the content thereof being herein incorporated by reference.

What is claimed is:

1. A dry air supply device for supplying, into a target space, dry air from which moisture and organic materials have been removed, the device comprising:
a plurality of rotors disposed in series, each of which is configured to carry an adsorbent thereon and is rotatably supported;
partition members which are arranged at outermost end portions of the rotors and between the rotors so as to partition a rotary zone of each rotor into an adsorption zone, a regeneration zone and a cooling zone;
a driving member which rotatably drives the rotors;
a supply passage which allows sucked air to pass through the adsorption zone to obtain dry air from which moisture and organic materials have been removed, and which supplies the dry air into the target space; and
an exhaust passage which allows a portion of the dry air to pass through the cooling zone, then heats the cooled air, and then allows the heated air to pass through the regeneration zone to separate the moisture and the organic materials from the adsorbent thereby.

2. The dry air supply device according to claim 1, wherein the partition members include:
a circumferential member having a circumferential sealing portion; and
radial members having radial sealing portions.

3. The dry air supply device according to claim 2, wherein the circumferential sealing member includes:
rotary-side fins which are concentrically formed on an outer peripheral portion of an end portion of the rotor; and
fixed-side fins which are concentrically formed on the partition members such that the fixed-side fins are alternately overlapped to the rotary-side fins in a non-contact manner.

4. The dry air supply device according to claim 2, wherein the radial sealing portion includes a plurality of fins which are formed in parallel with the radial members, and has a structure which allows air to pass through at approximately a center portion among the fins.

5. The dry air supply device according to claim 1, wherein the rotors are set to have rotational speeds which exhibit optimum characteristics, respectively.
